(19) United States
(12) Patent Application Publication
(10) Pub. No.: US 2025/0046877 A1
(43) Pub. Date: Feb. 6, 2025

(54) LITHIUM METAL BATTERY SOLVENT

(71) Applicant: WILDCAT DISCOVERY TECHNOLOGIES, INC., San Diego, CA (US)

(72) Inventors: Hui Wang, San Diego, CA (US); Jinhua Huang, San Diego, CA (US); Ye Zhu, San Diego, CA (US); Gang Cheng, Sen Diego, CA (US)

(21) Appl. No.: 18/716,419

(22) PCT Filed: Oct. 13, 2022
(86) PCT No.: PCT/US2022/046525

§ 371 Date: Jun. 4, 2024

Related U.S. Application Data
(60) Provisional application No. 63/288,903, filed on Dec. 13, 2021.

(51) Int. Cl. H01M 10/0569; H01M 4/02; H01M 10/0525; H01M 10/0568

(52) U.S. Cl. CPC H01M 10/0569; H01M 10/0525; H01M 10/0568; H01M 2004/027; H01M 2300/0034; H01M 2300/0037

(57) ABSTRACT

An electrolyte composition comprising a fluoroamino solvent and a lithium salt comprised of boron dissolved in the fluoroamino solvent, the fluoroamino solvent being a fluoroacetamide or fluoroimide may be used as an electrolyte in a secondary battery. The electrolyte composition is useful for lithium ion batteries having an anode comprised of lithium metal and the electrolyte may be present in a lean amount.

### BACKGROUND

Rechargeable lithium metal batteries (LMBs), those having a lithium metal anode, could potentially double the cell-level energy of state-of-the-art lithium ion batteries (LIBSs) compared to those containing a carbon anode, due to the extremely low density, high theoretical capacity, and negative redox potential of Li metal. Unfortunately, the commercialization of LMBs is very challenging due to the high reactivity of Li metal anode, the formation of an unstable solid electrolyte interphase (SEI), the growth of Li dendrites, the evolution of inactive Li during the Li plating and stripping, and the volume change during the battery operation. These consequences eventually lead to a low coulombic efficiency (CE), shortened battery life, sluggish electrode kinetics and safety issues.

Accordingly, it would be desirable to provide an electrolyte composition that improves or addresses one or more of the problems of an LMB.

### SUMMARY

Applicant has discovered that a composition comprised of a fluoroamino solvent and boron containing salt improves the coulombic efficiency and life of a LMB even under lean electrolyte loadings. Lean electrolyte (composition) loading herein is an amount of electrolyte that is at most 10× the volume of the open porosity (i.e., porosity accessible to the electrolyte) in the anode, cathode and separator of a battery and may be at most 7× or 5× the volume of the open porosity. The composition desirably comprises the fluoroamino solvent and a second solvent that is a cyclic carbonate.

A composition that comprises a fluoroamino solvent and a lithium salt comprised of boron dissolved in the fluoroamino solvent, the fluoroamino solvent being a fluoroacetamide or fluoroimide may be useful as an electrolyte in a battery and in particular a secondary battery. The composition is particularly useful as the electrolyte in a secondary battery comprising an anode comprised of a lithium metal anode with the cathode and separator being any suitable ones such as those known in the art.

### DETAILED DESCRIPTION

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

The terms “halo” and “halogen” as used herein refer to an atom selected from fluorine (fluoro, —F), chlorine (chloro, —Cl), bromine (bromo, —Br), and iodine (iodo, —I).

The term “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Aliphatic groups may contain 1-40 carbon atoms, 1-20 carbon atoms, 2-20 carbon atoms, 1-12 carbon atoms, 1-8 carbon atoms, 1-6 carbon atoms, 1-5 carbon atoms, 1-4 carbon atoms, 1-3 carbon atoms, or 1 or 2 carbon atoms. Exemplary aliphatic groups include, but are not limited to, linear or branched, alkyl and alkenyl groups, and hybrids thereof such as (cycloalkyl)alkyl, (cycloalkenyl)alkyl or (cycloalkyl)alkenyl. The aliphatic groups may be unsubstituted or substituted. Substituted means that one or more C or H atoms is replaced with oxygen, boron, sulfur, nitrogen, phosphorus or halogen. Typically, one to six carbon atoms may be independently replaced by the aforementioned and in particular oxygen, sulfur or nitrogen. The aliphatic group may have one or more “halo” and “halogen” atoms selected from fluorine (fluoro, —F), chlorine (chloro, —Cl), bromine (bromo, —Br), and iodine (iodo, —I).

The term “alkenyl,” as used herein, denotes a monovalent group derived from a linear or branched unsubstituted aliphatic group having at least one carbon-carbon double bond by the removal of a single hydrogen atom. The term “alkyl” means monovalent group derived from a linear or branched saturated unsubstituted aliphatic group.

The composition is useful for making lithium metal batteries. The composition comprises a fluoroamino solvent and a boron containing lithium salt dissolved in the solvent. The fluoroamino solvent is a fluoroacetamide, fluoroimide or mixture thereof. Suitable fluoroacetamides may be represented by:

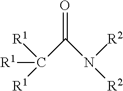

where each R¹ is F, H, or hydrocarbyl group with at least one R¹ being F and R² is a hydrocarbyl group. Typically, R¹, if not F, is H or a substituted unsubstituted alkyl or akenyl having 1 to 6 or 12. Desirably, at least two R¹s or each R¹ is an F. Typically, at least one R² is cyclic, branched or linear substituted or unsubstituted alkyl or alkenyl group of 1 to 12 or 6 carbons including where both R²s form a fused substituted or unsubstituted cyclic ring. Desirably, R² is an alkyl having 1 to 6 carbons such as a methyl or ethyl group.

Exemplary fluoroacetamides include 2,2difluoroacetamide; 2,2,2trifluoracetamide; 2,2,2trifluoro N,N-dimethylacetamide; 2,2,2 trifluoro N-methylacetamide, 2,2,2 trifluoro N,N-diethylacetamide and 2,2,2 trifluoro N-ethylacetamide.

Suitable fluoroimides may be represented by:

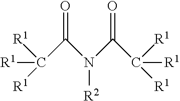

where R¹ and R² is as described for the fluoroacetamide.

The fluoroacetamide and fluoroimides suitable may those available such as from Sigma Aldrich or synthesized by known methods such as described in NASA technical report TN D6836, incorporated herein by reference. Suitable herein generally means all of the solvents and salts have a moisture content of at most about 20 parts per million by weight and generally are at least about 98% or 99% pure, which is generally referred to in the art as “battery grade”.

The fluoroamino solvent may be mixed with a second solvent to realize one or more desired effects. When the fluoroamino solvent is mixed with a second solvent, the amount of the fluoroamino solvent is typically at least about 10%, 15% 25%, 50% to at most about 99%, 95%, 90% or 85% by volume of all the solvents. Desirably, the fluoroamino solvent is the primary solvent (i.e., greater than 50% by volume of the solvents).

Generally, the second solvent is any solvent that may be miscible with the fluoroamino solvent at concentrations useful in secondary batteries such as lithium ion batteries or lithium metal batteries. Typically, the second solvent may be ones that impart one or more desired useful characteristics such as formation of a protective solid electrolyte interface (SEI) layer on the anode or cathode of the battery. Second solvents, for example, may be linear or cyclic carbonates or lactones (substituted or unsubstituted) that may be useful in lithium ion batteries. Desirably, the second solvent is a cyclic carbonate and in particular cyclic carbonates substituted with at least one fluoro group or alkenyl group. The cyclic carbonate may be 1,3-dioxolan-2-one (ethylene carbonate) or a substituted 1,3-dioxolan-2-one including 2H-1,3-dioxol-2-one (vinylene carbonate), wherein the substitution may be as described for R¹ or R² above. Desirably, the second solvent is only substituted with O, N or a halogen (e.g., F).

Exemplary second solvents may be one or more of methyl (2,2,2-trifluoroethyl) carbonate; ethylene carbonate; propylene carbonate; fluoroethylene carbonate; difluoroethylene carbonate; vinylene carbonate; dimethyl carbonate; ethylmethyl carbonate; diethyl carbonate; 4-(2,2,3,3,4,4,5,5,5-nonafluoropentyl)-1,3-dioxolan-2-one (NFPEC); and 4-((2,2,3,3-tetrafluoropropoxy)methyl)-1,3-dioxolan-2-one (HFEEC); 4,5-dimethylene-1,3-dioxolan-2-one; 4-methylene-1,3-dioxolan-2-one; 4-vinyl-1,3-dioxolan-2-one; 4-fluoro-1,3-dioxolan-2-one; 4-methylene-5-methyl-1,3-dioxolan-2-one; 4-methylene-5,5-dimethyl-1,3-dioxolan-2-one; 4-ethylidene-1,3-dioxolan-2-one; γ-butyrolactone (GBL); methyl butyrate (MB) and propyl acetate (PA).

The lithium salt comprised of boron (“boron salt” herein) may be any such useful salt that dissolves in the fluoroamino solvent at useful concentrations for use as an electrolyte in a secondary battery. A secondary battery is one that is comprised of a cathode, anode, electrolyte and separator and is rechargeable through a reversible electrochemical reaction. Desirably, the boron salt is comprised of an electron withdrawing group such as —F or —CF₃. Typically, the boron salt may be represented by:

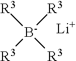

where R³ is an aliphatic group as described above, but desirably without substitution by S or P. Typically, at least one R³ group is a F or —CF₃ group. Adjacent R³ groups may form a substituted (e.g., O or N substituted) or unsubstituted cyclic ring having 5 to 8 atoms in the ring such as in lithium bis(oxalato)borate salt. Desirably, when the R³s form a cyclic ring the cyclic ring is an oxygen substituted ring that is an ester, ether or carbonate having 5 to 8 atoms in the ring. R³ may be an alkyl or alkenyl group as previously described above for R² or R¹.

There may be at least two boron salts in the composition. Desirably each of the boron salts has a fluoro group bonded to the boron. One of the two or more salts desirably has at least two adjacent R³s that form a substituted cyclic aliphatic group of 5 to 8 atoms such as lithium difluoro(oxalato)borate or lithium bis(oxalato)borate and the other salt may be lithium tetrafluoroborate. When two salts are present and one of them is the boron salt having the aforementioned cyclic group, it desirably is present in amount of least 50% by mole of the lithium salt comprised of boron in the composition.

Further exemplary lithium salts comprised of boron may include Li₂B₁₀Cl₁₀, Li₂B₁₀F₁₀, Li₂B₁₂FₓH₍₁₂₋ₓ₎ wherein x=0-12; lithium salts of chelated; orthoborates such as lithium bis(malonato) borate [LiB(O₂CCH₂CO₂)₂], and lithium bis(difluoromalonato) borate, lithium (malonatooxalato) borate.

The amount of lithium salt comprised of boron in the composition may be any amount that is useful in a secondary battery. Typically, the concentration of the boron salt in the composition may be from about 0.5 M to 7 M, 5 M, 3 M or 2 M (molarity).

The composition is useful in a battery such as a secondary battery comprised of an anode, cathode and separator. The anode may be any suitable anode such as graphitic, but in particular lithium metal anodes. Lithium metal herein may be essentially pure lithium or an alloy of lithium, where the lithium typically is the primary metal (i.e., >50% by volume) of the metal alloy. The lithium metal alloy may be comprised of Li and one or more metal or metalloid atoms from groups 1, 2 13 or 14 of the periodic table with examples being Al, Sr, Si, Ge, Mg or Ca.

The separator may be any material generally used in lithium ion batteries, such as nonwoven fibers (e.g., nylon and polyester), microporous polymer films (e.g., polyethylene polypropylene, polytetrafluoroethylene and copolymers thereof), ceramics and combinations thereof.

The cathode may be any useful material generally used in a lithium ion battery. For example, the cathode may be a lithium transition metal oxide, phosphate, sulfide or the like. Examples of such cathode materials is described in U.S. Pat. No. 9,799,922 from col. 7, line 63 to col. 8, line 35, incorporated herein by reference.

The battery comprised of the composition desirably has a lean amount of the composition (electrolyte) as defined above. The amount of open porosity of the cathode, anode and separator available to the electrolyte may be determined by known methods of determining porosity such as mercury intrusion porosimetry using know mercury or liquid intrusion porosimeters available from Anton Paar and Porous Materials Inc.

### ILLUSTRATIVE EMBODIMENTS

### Example 1 and Comparative Examples 1

Example 1 and Comparative Example 1 battery cells are made with the same materials other than the solvent used. The anode is a 20 micrometer thick film of lithium on a copper foil. All materials are commercially available battery grade or rendered battery grade by drying (e.g., drying of the solvents using molecular sieves). The cathode is a nickel-manganese-cobalt oxide in the molar ratio of 6:2:2 (Li(Ni_{0.6}Mn_{0.2}Co_{0.2})O₂. The Example 1 solvent is 2,2,2trifluoro N,N-dimethylacetamide (FDMA). The Comparative Example 1 solvent is ethylene carbonate (EC). The amount of solvent used is about 5× the open porosity present in the cathode, anode and separator. The salt dissolved in the solvent is 0.7 M lithium difluoro (oxalato) borate-0.7 M lithium tetrafluoroborate (0.7 M LiDFOB-0.7 M LiBF4).

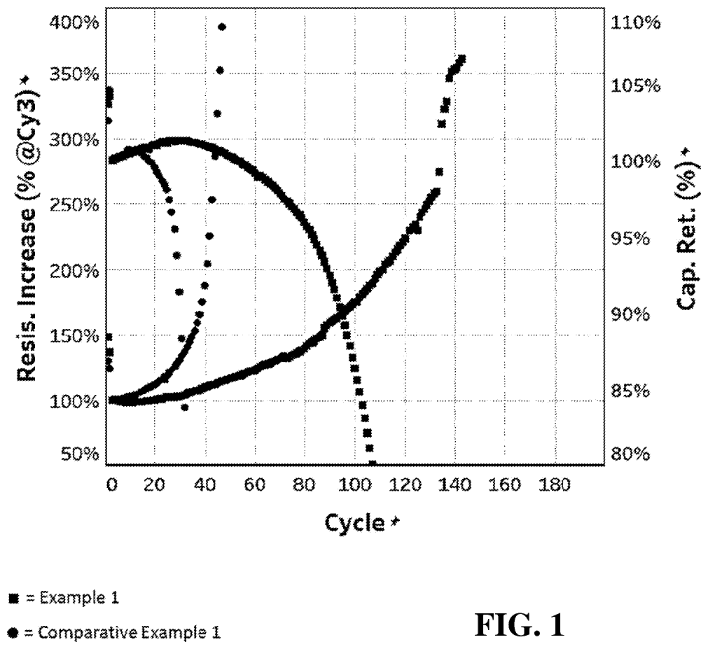

The formation cycle is 12 hours OCV (open circuit voltage) hold, followed by a C/10 charge to 4.3 V with a CV (constant voltage) hold until the charge current is smaller than 0.025 C, and then a C/10 discharge to 3.0V at 30° C. The process is repeated twice to complete the formation cycle. Cells are then cycled between 4.3 V and 3V with 0.33 C charge and 0.33 C discharge cycling rate. (C=1 mA/cm²). The results are shown in FIG. 1, where the Resistance Increase and Capacity Retention of Example 1 is substantially improved compared to Comparative Example 1.

### Examples 2-5

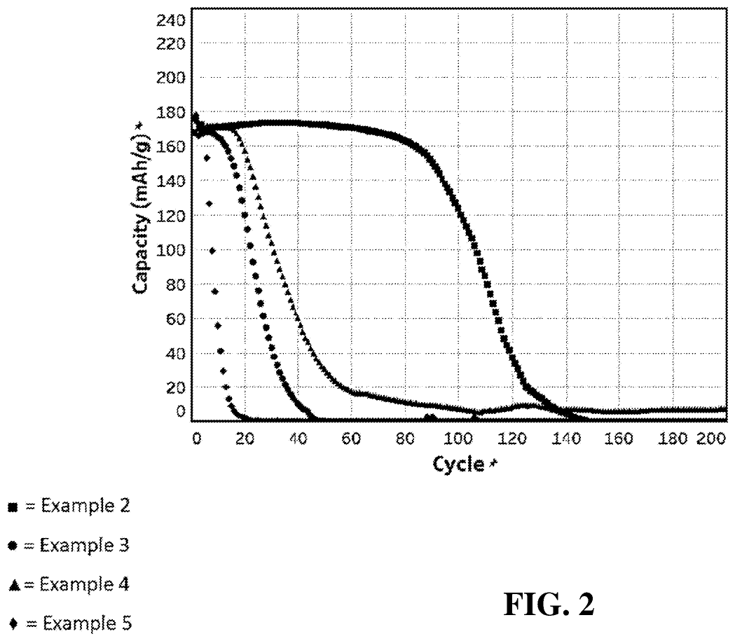

Battery cells are made in the same manner as Example 1 except that a co-solvent is used with the FDMA. The FDMA comprises 85% by volume of the solvent and the remainder is the co-solvent. The co-solvents for each Example 2 to 5 are shown in Table 1. The results of cycling the Examples 2-5 cells are shown in FIG. 2, where it is evident that the FEC, a cyclic carbonate, improves the cycle life of the battery.

TABLE 1

| Example | Co-solvent |
|---|---|
| 2 | Fluoroethylene carbonate (FEC) |
| 3 | 1,3,2-Dioathiolane-2,2-dioxide (DTD) |
| 4 | Hexafluoroisopropyl trifluoromethanesulfonate (HFIP TFMS) |
| 5 | ethyl difluoroacetate (FAc) |

TABLE 2

| | LiDFOB | LiBF₄ | FDMA Vol. % | FEC Vol. % |
|---|---|---|---|---|
| Example | Conc. (M) | Conc. (M) | of solvent | of solvent |
| 2 | 0.7 | 0.7 | 85 | 15 |
| 6 | 1.0 | 0.4 | 97.5 | 2.5 |
| 7 | 1.0 | 0.4 | 50 | 50 |
| 8 | 1.0 | 0.4 | 85 | 15 |

### Examples 6-8

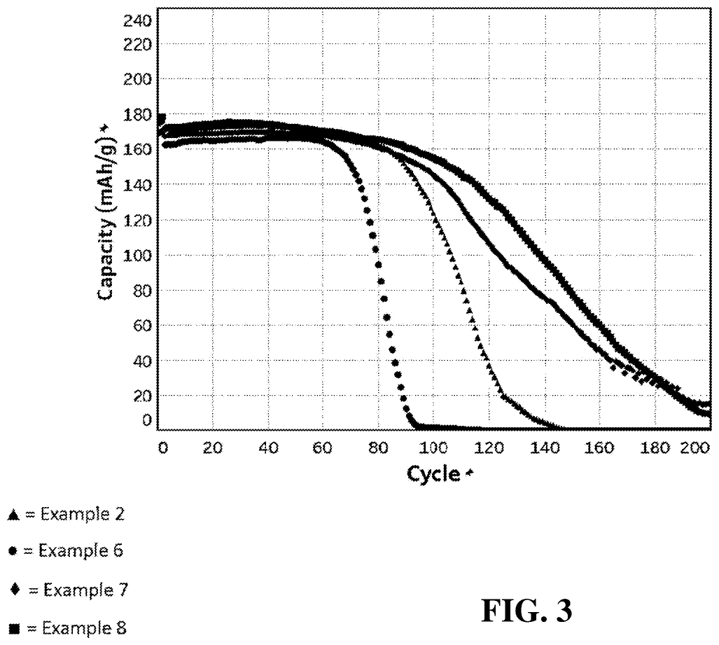

The battery cells are made in the same manner as the cell of Example 2 except that the concentrations of the salts and the solvent proportions are varied as shown in Table 2. The results of cycling of these cells are shown in FIG. 3. The results indicate that the concentration of the fluoroamino solvent (FDMA) desirably is one of the major high dielectric solvent components (e.g., typically at least about 50% by volume of the solvent) but that too much of the fluoramino solvent results in reduced cycle life (i.e., greater than about ˜97% of the solvent). (see Examples 6-8). The results also indicate that improvements in the cycle life may arise from increasing the ratio of the salt having a cyclic substituted lithium boron salt (LiDFOB) when mixed with a boron salt lacking a cyclic substituent (LiBF₄).

1. A composition comprising a fluoroamino solvent and a lithium salt comprised of boron dissolved in the fluoroamino solvent, the fluoroamino solvent being a fluoroacetamide or fluoroimide, wherein the fluoroamino solvent comprises 10% to 90% by volume of the solvent.

2. The composition of claim 1, wherein the fluoroamino solvent is comprised of a fluoracetamide represented by: 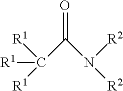
or fluoroimide represented by: 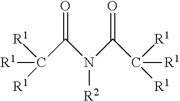
where each R¹ is F, H, or alkyl having 1 to 12 carbons with at least one R¹ being F and R² is an alkyl, alkenyl, substituted alkyl or substituted akenyl having 1 to 12 carbons.

3. (canceled)

4. The composition of claim 2, wherein each R¹ is F.

5. The composition of claim 2, wherein at least one R² is cyclic, branched or linear or both R²s form a fused cyclic ring.

6. (canceled)

7. (canceled)

8. (canceled)

9. The composition of claim 1 further comprising a second solvent.

10. The composition of claim 9, wherein the second solvent is comprised of a linear or cyclic carbonate.

11. A composition of claim 10, wherein the second solvent is comprised of a cyclic carbonate.

12. The composition of claim 10, wherein the second solvent has at least one F.

13. The composition of claim 10, wherein the second solvent is comprised of one or more of methyl (2,2,2-trifluoroethyl) carbonate, ethylene carbonate, fluoroethylene carbonate, difluoroethylene carbonate, 4-(2,2,3,3,4,4,5,5,5-nonafluoropentyl)-1,3-dioxolan-2-one (NFPEC), and 4-((2,2,3,3-tetrafluoropropoxy)methyl)-1,3-dioxolan-2-one (HFEEC).

14. (canceled)

15. The composition of claim 1, wherein the fluoroamino solvent comprises at least 50% by volume of the solvent.

16. (canceled)

17. The composition of claim 1, wherein the lithium salt comprised of boron is comprised of at least one electron withdrawing group —F or —CF₃ bonded to the boron.

18. The composition of claim 17, wherein the lithium salt comprised of boron is comprised of one or more boron salts represented by: 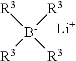
where R³ is a substituted or unsubstituted aliphatic group having from 1 to 20 carbon atoms.

19. The composition of claim 18, wherein at least two adjacent R³s are a substituted cyclic aliphatic group of 5 to 8 atoms.

20. (canceled)

21. (canceled)

22. The composition of claim 18, wherein there are at least two boron salts.

23. The composition of claim 22, wherein each of the boron salts has a fluoro group bonded to the boron.

24. The composition of claim 23, wherein at least one of the salts has at least two adjacent R³s that are a substituted cyclic aliphatic group of 5 to 8 atoms

25. (canceled)

26. (canceled)

27. The composition of claim 22, wherein one of the boron salts is one that has a cyclic substituted aliphatic group and it is present in an amount of least 50% by mole of the lithium salt comprised of boron in the composition.

28. The composition of claim 27, wherein the boron salt having the cyclic substituted aliphatic group is lithium difluoro(oxalato)borate or lithium bis(oxalato)borate and the other boron salt is lithium tetrafluoroborate.

29. (canceled)

30. (canceled)

31. A secondary battery comprised of the composition of claim 1.

32. The secondary battery of claim 31, wherein the secondary battery is comprised of an anode comprising a lithium metal.

33. (canceled)

34. (canceled)
